(19) United States
(12) Patent Application Publication
(10) Pub. No.: US 2013/0295346 A1
(43) Pub. Date: Nov. 7, 2013

(54) DECORATIVE MONOLITHIC, FUNCTIONALLY BONDED COMPOSITE SURFACE OVERLAYMENT SYSTEM AND APPLICATION PROCESS

(71) Applicant: RENEWABLE TECHNOLOGY HOLDINGS, INC., Lake Park, FL (US)

(72) Inventors: Samuel Ferguson, Vero Beach, FL (US); Brian Ireland, Palm Beach Gardens, FL (US)

(73) Assignee: RENEWABLE TECHNOLOGY HOLDINGS, INC., Lake Park, FL (US)

(21) Appl. No.: 13/629,775

(22) Filed: Sep. 28, 2012

Related U.S. Application Data
(60) Provisional application No. 61/643,709, filed on May 7, 2012.

(51) Int. Cl. E04C 2/26; B32B 37/12

(52) U.S. Cl. CPC E04C 2/26; B32B 37/12
USPC 428/196; 156/60; 156/331.7; 156/327; 156/275.5; 428/195.1; 428/201; 428/210

(57) ABSTRACT

The present invention describes a decorative surface covering comprising a plurality of component layers, structural and/or chemical, chemically bonded to the surface, together forming a unique single unit, monolithic decorative surface overlay, referred to generally herein as a functionally bonded system. The functionally bonded system is designed to be flexible, expandable, and functional, providing the same durability as pre-existing flooring or horizontal surfaces. While the individual components have various properties, the chemical bonding of one layer to an adjacent layer above and/or below provides for a unique surface covering that is decorative and functional. The functionally bonded system can be installed, retrofitted and bonded to a raw concrete floor foundation, countertops and other horizontal surfaces or to such surfaces having an existing ceramic tile, porcelain tile, concrete, VCT (Vinyl), asbestos (VAT) composite tile, hardwood floor, laminate or engineered wood floor, other synthetic or natural materials, or glass or architectural glass.

### REFERENCE TO RELATED APPLICATIONS

In accordance with 37 C.F.R 1.76, a claim of priority is included in an Application Data Sheet filed concurrently herewith. Accordingly, the present invention claims priority under 35 U.S.C. §119(e) to U.S. Provisional Application 61/643,709 entitled “DECORATIVE COMPOSITE FLOOR SURFACE OVERLAYMENT SYSTEM AND APPLICATION PROCESS WITH MONOLITHIC FINISH” filed on May 7, 2012; to U.S. Provisional Application 60/918,423, entitled “DECORATIVE COMPOSITE TILE FLOOR OVERLAYMENT APPLICATION PROCESS WITH MONOLITHIC FINISH” filed on Nov. 28, 2011; and to U.S. Provisional Application 60/185,139, entitled “DECORATIVE COMPOSITE TILE FLOOR OVERLAYMENT APPLICATION PROCESS WITH MONOLITHIC FINISH” filed on Sep. 28, 2011. The contents of each of the above referenced applications are herein incorporated by reference in its entirety.

### FIELD OF THE INVENTION

The present invention relates to systems and methods useful for residential and business improvement projects, such as remodeling or restoration, as well as in the construction industry; and more particularly to a functional and functionally bonded system and method of forming and/or installing the functional and functionally bonded system, using functional chemical anchoring to provide a high quality, functional monolithic surface with decorative finishes for use in residential or commercial surface applications.

### BACKGROUND OF THE INVENTION

Whether commercial or residential, structures housing individuals and/or other objects are ubiquitous. Because such buildings are designed to be interactive with individuals, many aspects of the buildings include aesthetically pleasing features. For example, it is not uncommon for such structures to contain finished floors and walls. While not required for the structural integrity, these features are deemed vital despite adding additional expense to the overall construction and maintenance. In fact, an entire industry dedicated to providing aesthetic appeal to building structures exists.

Numerous materials are known to be used in flooring, walls, and countertops for providing both functional uses, i.e. can be walked on, supportive of large/heavy objects without risk of collapse, as well as decorative appeal. Such materials include marble, stone, natural woods, laminate woods, tiles, and glass. Moreover, such materials may be designed to have a particular appeal, such as through the arrangement of decorative patterns or colors. Use of these materials further allows building owners, whether individuals, corporations, or other institutions, such as hospitals and governmental agencies, the ability to customize an appearance and create visual experiences unique to that individual or organization.

Renovations in the home, business, or other institutional settings allow for the capability to change the appearance of the inside of the building without the need for building a new structure. In fact, residential renovation is estimated to be a $300 billion dollar a year industry. Typical renovations include covering the walls or floors with ceramic tile materials, wood or naturally occurring stone materials such as marble or granite. Use of such materials not only adds aesthetic appeal, but these materials have favorable functional properties, including being made of hard-wearing materials having high breaking and wear resistance.

While renovation offers a much cheaper mechanism to change the room appearance, current procedures are not without problems. Despite being cheaper, use of exotic woods or certain marbles or granites are costly and can require special care when installing, often requiring skilled labor to install properly. Current procedures for floor coverings involve extensive labor and time, and require securing means to ensure that the individual components that make up the floor remain secured to the original structure. Numerous securing means are known in the art, and include adhesive bonding or mechanical fastening, such as use of securing members including screws or nails. Mechanical bonding is useful in wood flooring applications, but can be subject to failure due to corrosion and/or improper types of securing members, and requires time and tools.

For installation procedures using tiles, securing procedures include fixing individual tiles in place by means of adhesive, either by applying a thin coating of a commercially manufactured product or by spreading an onsite mixed, cement-based composition over the floor or wall foundations to provide a bedding layer for the tiles. The fixing of flooring with adhesive is simple and relatively cheap. However, adhesives form a superficial bond, and are subject to failure, requiring fixing or replacement. While initially offering a cheaper means of home renovation, fixing or total replacement of improperly secured tiles requires additional funding, time and labor. Since flooring systems are affected by rising dampness, moisture, temperature, or foundation surfaces that are non-uniform, crumbly, and dusty development of underlying structural issues can result in failure, cracking, and susceptibility to water damage, adhesive based flooring will eventually need to be re-sealed.

In addition to the problems associated with securing the material to the floor, additional time and inconvenience is added to the process as a result of the requirement that the individual components must be added to the surface free of pre-existing structures. Accordingly, prior to applying the tiles or wood planks, all previously existing flooring structures must be removed. Removal of baseboard millwork or any other millwork or trim associated with the floor geometry must be removed. Such removal provides additional work and potential damage to any structure that may be reusable provided they are not subject to damage, shattering or demolition from the removal process. For those structures not damaged, additional time and labor is required to re-install them to the refinished floor.

Finally, there exists current interest in using sustainable building materials and using green technologies. High-end flooring systems using marble, granite, and woods require the harvesting of natural products from the environment. Not only does this destroy natural resources, but a tremendous amount of energy is required to obtain such products and process them into usable products. Installation for these products typically requires harsh chemicals that are not environmentally friendly. Moreover, many residential, commercial, and industrial buildings built in the early 1900's used asbestos flooring, a known carcinogen. Traditional methods of removing or sealing the asbestos are expensive, labor intensive, and carry a risk of exposure to the carcinogen.

Therefore, what is needed in the art is an alternative, improved flooring system which provides 1) a highly desirable appearance replicating the look of natural materials such as stone, granite, marble or wood, or depicts abstract or other desirable images; 2) is durable and functions similar to or better than standard floorings; 3) is cheaper and easier to install than existing materials; and 4) can be installed over existing flooring systems or surfaces.

### SUMMARY OF THE INVENTION

The present invention describes a decorative surface covering comprising a plurality of component layers, structural and/or chemical, chemically bonded together to form a unique single unit, decorative monolithic functionally bonded system, referred to generally herein as a functionally bonded system. While the individual components have various properties, the chemical bonding of one layer to an adjacent layer above and/or below provides for a unique surface covering that is durable, decorative, and functional, i.e. can support individual and other structures without collapse or damage. While the present invention is primarily described as an interior/exterior flooring surface overlay, countertops and other horizontal surfaces can be enhanced using the unique monolithic decorative surface overlay and methods of forming and/or applying the monolithic decorative surface overlay.

The functionally bonded system can be installed, retrofitted and bonded to a raw concrete floor foundation or an existing ceramic tile, porcelain tile, concrete, VCT (Vinyl) composite tile, hardwood floor, laminate or engineered wood floor, other synthetic or natural materials, asbestos tiles, asbestos floors, asbestos walls, asbestos ceilings, or any other surface requiring re-facing, restoration, or renovation of existing surfaces without removing or disturbing the existing surface or surfaces. The functionally bonded system is designed to be flexible and expandable. It will not show cracks that exist before or form after installation in the underlying surface on which it is installed. The functionally bonded system applied to the existing floor is thin enough to allow multiple functionally bonded systems to be applied over a first application. The functionally bonded system is designed to be repairable by recoating damaged areas and buffing, or applying additional components to part of or to the entire floor. Additionally, the system in accordance with the present invention provides for a functionally bonded adhesion to surfaces such as concrete, ceramic tile, laminate tile, vinyl composite tile and engineered wood composite floor materials through the activated functional chemical bonds instead of traditional mechanical bonding. The system also maximizes any degradation of concrete or other surfaces and adds density to the any surface to block moisture and vapor transmission. There are no changes to the dimensions or physical characteristics of the preexisting surface.

As an illustrative embodiment, the monolithic, decorative and functional surface overlay system in accordance with the present invention may comprise a base layer composition, said base layer composition having one or more components that forms a permanent bond with a substrate to form a base layer-substrate composition and a substrate; and a decorative image overlay having at least one form of printed indicia printed thereto, said decorative image overlay bonded with said base layer-substrate composition to form a monolithic, decorative and functional surface overlay, and a protective layer composition, said protective layer secured to said monolithic, decorative and functional surface overlay.

An illustrative example of a method of applying a monolithic, decorative and functional surface overlay system to a surface in accordance with the present invention comprises the steps of identifying a surface of a substrate to be covered with a monolithic, decorative and functional surface overlay system; applying a base layer composition to said substrate surface; forming a first portion of a multi-component monolithic, decorative and functional surface overlay, said first portion formed by a bond between said base layer and said substrate thereby forming a base layer-substrate unit; applying a decorative layer having at least one form of printed indicia thereto, said second layer adapted to form a chemical bond with said base layer-substrate composition; bonding said decorative layer to said base layer-substrate unit to form a second portion of said multi-component monolithic, decorative and functional surface overlay; and applying an adhesive sealant to encapsualte said bonded decorative layer.

Accordingly, it is an objective of the present invention to provide a surface covering which is decorative and functional.

It is a further objective of the present invention to provide a decorative and functional floor surface covering.

It is yet another objective of the present invention to provide a monolithic, decorative and functional floor surface made of individual components.

It is a still further objective of the present invention to provide a monolithic, decorative and functional floor surface overlay made of individual components chemically bonded to adjacent layers.

It is a further objective of the present invention to provide a monolithic, decorative and functional floor surface overlay which can be applied to pre-existing flooring surface types.

It is yet another objective of the present invention to provide a monolithic, decorative and functional floor surface overlay which can be applied to flooring surfaces having pre-existing natural materials.

It is a further objective of the present invention to provide a monolithic, decorative and functional floor surface overlay which can be applied to flooring surfaces having pre-existing synthetic materials.

It is yet another objective of the present invention to provide a monolithic, decorative and functional floor surface overlay which uses environmentally safe chemicals having low volatile organic compounds (VOCs).

It is a still further objective of the present invention to provide a monolithic, decorative and functional floor surface overlay which replicates the image of a natural material such as stone, wood, granite, or marble.

It is yet another objective of the present invention to provide a monolithic, decorative and functional floor surface overlay having a layer which contains a custom decorative image.

It is a further objective of the present invention to provide a monolithic, decorative and functional floor surface overlay which can be installed by unskilled personnel.

It is a still further objective of the present invention to provide a monolithic, decorative and functional floor surface overlay which does not require sophisticated tools for installation.

It is a further objective of the present invention to teach a method of forming and/or installing a surface covering which is decorative and functional.

It is yet another objective of the present invention to teach a method of forming and/or installing a decorative and functional floor surface covering.

It is a still further objective of the present invention to teach a method of forming and/or installing a monolithic, decorative and functional floor surface made of individual components.

It is a further objective of the present invention to teach a method of forming and/or installing a monolithic, decorative and functional floor surface overlay made of individual components chemically bonded to adjacent layers.

It is yet another objective of the present invention to teach a method of forming and/or installing a monolithic, decorative and functional floor surface overlay which can be applied to pre-existing floors.

It is a still further objective of the present invention to teach a method of forming and/or installing a monolithic, decorative and functional floor surface overlay which does not require mechanical manipulation of the pre-existing flooring system.

It is a further objective of the present invention to teach a method of forming and/or installing a monolithic, decorative and functional floor surface overlay to an existing flooring system which does not require removal or destruction of peripheral portions, such as base boards, of a pre-existing flooring system.

It is yet another objective of the present invention to teach a method of forming and/or installing a monolithic, decorative and functional floor surface overlay to an existing flooring system which uses environmentally safe chemicals having low VOCs.

It is a still further objective of the present invention to teach a method of forming and/or installing a monolithic, decorative and functional floor surface overlay to an existing flooring system which can be carried out by unskilled personnel.

It is yet another objective of the present invention to teach a method of forming and/or installing a monolithic, decorative and functional floor surface overlay which replicates the image of a natural material such as stone, wood, granite, or marble.

It is a further objective of the present invention to teach a method of forming and/or installing a monolithic, decorative and functional floor surface overlay which can be applied to flooring surfaces having a pre-existing natural material.

It is yet another objective of the present invention to teach a method of forming and/or installing a monolithic, decorative and functional floor surface overlay which can be applied to flooring surfaces having a pre-existing synthetic material.

It is a still further objective of the present invention to teach a method of forming and/or installing a monolithic, decorative and functional floor surface overlay having a layer which contains a custom decorative image.

It is yet another objective of the present invention to teach a method of forming and/or installing a monolithic, decorative and functional floor surface overlay which encapsulates toxic materials, such as asbestos.

It is a still further objective of the present invention to teach a method of forming and/or installing a monolithic, decorative and functional floor surface overlay which encapsulates asbestos from a floor system having pre-existing materials utilizing asbestos.

It is a further objective of the present invention to teach a method of forming and/or installing a monolithic, decorative and functional floor surface overlay which does not require mechanical preparatory techniques.

It is yet another objective of the present invention to teach a method of forming and/or installing a monolithic, decorative and functional floor surface overlay which does not require evacuation of the premises during installation.

It is a still further objective of the present invention to teach a method of forming and/or installing a monolithic, decorative and functional floor surface overlay which does not require removal of baseboards or trim.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of an illustrative example of a functionally bonded system in accordance with the present invention;

FIG. 2A is a schematic cross sectional diagram illustrating the components of the functionally bonded system in accordance with the present invention;

FIG. 2B is a schematic top view illustrating the successive layers of the components of the functionally bonded system peeled away;

FIG. 3 is a schematic cross sectional diagram illustrating the components of an alternative embodiment of the functionally bonded system in accordance with the present invention;

FIG. 4 illustrates an embodiment of a support structure in accordance with the functionally bonded system illustrated in FIG. 3;

FIG. 5 is an alternative embodiment of the functionally bonded system in accordance with the present invention, shown installed in a residential setting;

FIG. 6 is an alternative embodiment of the functionally bonded system in accordance with the present invention, shown installed in a commercial setting;

FIG. 7 is an alternative embodiment of the functionally bonded system in accordance with the present invention;

FIG. 8 is an alternative embodiment of the functionally bonded system in accordance with the present invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

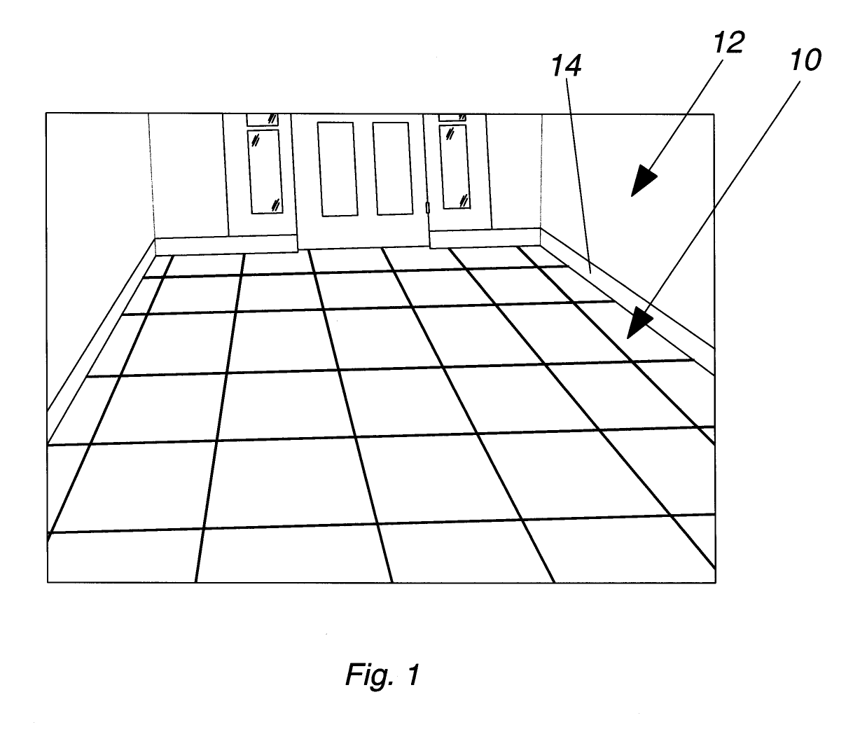

Referring to FIG. 1, an illustrative example of the functionally bonded system, referred to generally as 10, is shown. The functionally bonded system 10 is shown placed in an entry way 12 of a residential building and installed over an existing tile flooring system. Accordingly, the functionally bonded system 10 was installed without removal of the previously laid down tile. In addition, removal of the trim 14 around the perimeter of entry way 12 was not required as the installation of the functionally bonded system 10 was accomplished without a removal step.

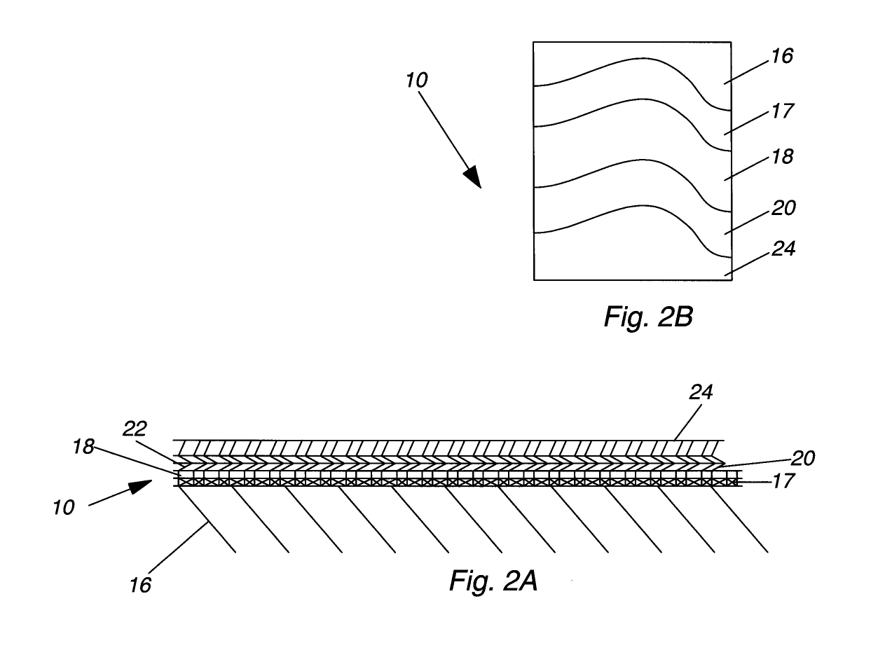

FIG. 2A is a diagrammatic cross sectional representation of the components of the functionally bonded system 10. The functionally bonded system 10 is designed to be compatible with a variety of substrates 16. For example, the functionally bonded system 10 is installable, retrofitted or bonded to a raw concrete floor. Alternatively, the functionally bonded system 10 is installable, retrofitted or bonded to other existing substrates, such as, but not limited to, ceramic tile, porcelain tile, composite tile such as vinyl composite tiles, hardwood floors, laminate floors or engineered wood flooring, stone, marble, asbestos tiles, asbestos floors, asbestos walls, asbestos ceilings, underlayment, synthetic boards, countertops, glass tops, or architectural glass.

A base coat 18 provides one layer of a chemically bonded layered system which stabilizes and chemically bonds to the substrate 16. The use of the base coat 18 as part of the functionally bonded system 10 offers several advantages over other systems. A chemically bonded layered system is vital to a robust bonded surfacing system, particularly the functionally bonded system 10 which is designed for encapsulation of toxic substances, such as asbestos. The chemically bonded layering system of the present invention provides solid bonded layers without the formation of mechanical bonds that can delaminate with physical abuse, exposure to chemicals, UV or moisture.

The base coat 18 chemically bonds to the substrate 16 using a pre-applied, or added to, etching and functional bonding treatment coat solution 17, see also FIG. 2B. Once secured together, the layers form a chemically bonded, solid substrate-base coat layer which cannot be separated into individual components without physical destruction of the layer. The chemically bonded, solid substrate-base coat layer forms the basis for subsequent layers to chemically bond and secure thereto. Preferably, the base coat 18 is made up of one or more compounds designed to provide a bonding layer that results in modifications to the individual components of the base coat to form strong bonds. For example, the base coat 18 can be designed to include one or more organic compounds that utilize functional bonding to provide secure, permanent, chemically bonded adhesion between the substrate 16 and the base coat layer 18. As used herein, the term “permanent” refers to the inability of any of the layers to separate without physical destruction. The use of a “permanent treatment” refers to a treatment which results in the activation of the surfaces which provides a functional reaction of subsequent polymer coatings, thereby providing a permanent installation. The term “functional bond” as used herein defines a chemical bonding using functional chemical groups, such as amines, such as primary amines, including but not limited to, methylamine, ethylamine, propylamine, 2-propylamine, cyclobutylamine, 1-2 ethyldiamine, secondary amines, including but not limited to N-methylmethylamine N-methylethylamine, N-ethylethylamine, N-methyl-2-propylamine, N-isopropylcyclobutylamine, or N,2-dimethyl-3-pentylamine, or tertiary amines, including but not limited to N,N-dimethylmethylamine, N,N-dimethylethylamine, N-ethyl-N-methylethylamine, N-ethyl-N-methyl-3-hexylamine, to form chemical bonding to other structures at the molecular level. Such functional groups, therefore, create a chemical condition allowing for molecular fusion, forming a monolithic unit comprising of one or more independent layers which eventually bond as one single unit. Accordingly, as each layer or coating is added to subsequent layers, the functionally bonded system 10 forms.

In an illustrative embodiment, the base coat 18 can be made of an aqueous hydroxyfunctional polyacrylic dispersion, such as Bayhydrol® A XP 2770 (Bayer MaterialScience, LLC, Pittsburgh, Pa.). Bayhydrol A XP 2770 is generally supplied in approximately 44.5% water/Dowanol®PnB, neutralized with dimethyl amino ethanol in the ratio of approximately 50.2:3.6:1.7. The base coat 18 may be crosslink cured with a hydrophilic aliphatic polyisocyanate, such as Bayhydur® XP 2655 (Bayer MaterialScience, LLC, Pittsburgh, Pa.). Bayhydur XP 2655 is an aliphatic polyisocyanate based on hexamethylene diisocyanate (HDI). The mixture may be thinned by adding 0.5%-99% distilled water, preferably approximately 10% distilled water to enhance the flow, thereby maximizing the ability to properly disperse the mixture onto the substrate 16.

The base coat 18 may be preceded or blended with a component that cleans and chemically activates the surface of the substrate, the etching and functional bonding treatment solution 17. To the compounds described above, the base coat 18 may further contain N—N-dimethylethanolamine (DMEA) as a solvent. The DMEA plays a critical role in preparing the surface of the substrate 16 for chemical bonding. The key to base coat layer 18 adhering to the substrate 16 is providing a substance which acts as a substrate activator and/or cleaner. The substrate activator and/or cleaner must not require abrasion for functionality, as such abrasion can cause potential release of airborne toxins, such as asbestos, from the substrate 16. The solvent diluted DMEA system cleans without causing airborne products, chemically activating the surface by providing a connecting amine bonded layer between the substrate 16 and the base coat 18. Tables 1A and 1B illustrate preferred embodiments the functional bonding treatment solution 17. Such functional bonding treatment solutions form an etching coat and provide for the functional bonding between the substrate 16 and the base coat layer 18 by activation of the functional bonding groups within one or more components of the functionally bonded system 10. The preferred functional bonding mechanism is through substances which activate the formation of chemical bonding of amines (i.e. an amine coupling activator).

TABLE 1A
Example 1: Functional Bonding Treatment Solution

| Component | Amount (wt: vol) |
|---|---|
| Solvent | Upto 30% |
| Alcohol | Upto 30% |
| Amine Coupling activator | Upto 30% |
| Water | Upto 30% |

TABLE 1B
Example 2: Functional Bonding Treatment Solution

| Component | Amount (wt: vol) |
|---|---|
| DMEA | 25% |
| Ethanol | 20% |
| DPNB (dipropylene glycol propyl | 25%% |
| ether) | |
| Distilled Water | 25% |

DMEA may also be used in conjunction with hydrophilic aliphatic polyisocyanate based hexamethyline diisocyanate, polyacrylate polymer, propylene glycol n-butyl ether.

While a chemically bonded system is preferable, other means of forming a single layer from two independent layers may be utilized. For example, one or more of the components of the system, i.e. the base coat, may contain ultra violet (UV) radiation curable materials, such as UV based chemicals or UV curable resin consists of monomer, oligomer, photopolymerization initiator (absorb the UV photon and transfer this energy to the curing process and various additives (stabilizers, fillers, pigments, etc.). The ultraviolet curing resins may be either free radical formulations or cationic formulations. Such UV curable materials will allow for one or more of the components of the functionally bonded system 10 to be secured and/or cured using UV radiation curing technology. If UV radiation curable materials are used with any of the individual components, i.e. the base coats or other coats, a method of ultra violet (UV) radiation curing technology, i.e. applying a UV source to the coats, can be implemented to cure one or more of the coatings. Using UV radiation curing technology speeds the overall process by providing for cure rates in a matter of minutes, as compared to hours, using standard finishing coating processes. The UV radiation curing technology allows for greater production, shorter cycle and final completion of the entire project. UV chemical curing technology may offer high level finishing and processing for quick turnaround abilities and minimal impact to the surrounding environments. UV radiation curing may also provide for a continuous finishing process that could provide the opportunity of completing thousands of square feet of floor surfaces in a short period of time or in the same day of installation. The floor surfaces can be put back into a usable surface within hours of final completion of projects.

The base coat 18 should include a substance, partially or in full, that has the characteristic of forming a strong bond to the substrate, preferably through bonding to amines, and may include polyisocyanates, i.e. compounds prepared from isocyanate, (organic compounds that contain an isocyanate group) or compounds containing multiple isocyanate functional groups. In addition to forming a strong bond, encapsulation of the substrate is insured thereby preventing any toxic compound, such as asbestos, used to form the substrate from escaping into the environment. Alternative embodiments of the base coat 18 may include other functional chemical groups that form a chemical bond in which the two layers become a single layer.

The base coat 18 may also contain colored compounds or pigments for providing tinting. A 100% acrylic emulsion, such as, but not limited to, a premium house paint like Behr Premium Plus Ultra with NanoGuard may be used for this purpose. The NanoGuard technology contains nanotubules which allow for the formation of a reinforced coating similar to fiberglass through matrix formation of coating filled nanotubules. Such matrix formation forms a structural film built to enhance robustness and adhesion.

Bonded to the base coat 18 is a decorative image overlay 20. The decorative image overlay 20 can be bonded to the base coat 18 using several different mechanisms. In one embodiment, the decorative image overlay 20 is an architectural grade or industrial grade decorative PVC film. The PVC film may be varied in thickness and size depending on the need of the user and the size of the surface to be covered. In an illustrative example, an approximately 6 mL thick architectural or industrial-grade polyvinylchloride (PVC) is printed with a decorative design in stone, marble, granite, wood, metal, abstract, logos, medallions, borders, or any other design. Images printed on the PVC architectural grade film may be accomplished using methods known to one of skill in the art, including ink jet, the Gravure or Calendared methods, or digital printing methods. Such method is well known in architectural vertical grade decorative applications, and can be used in the present invention for horizontal applications. Other film media, such as a white architectural grade decorative PVC film can be used and applied with a special clear polymer coating to the face side of the decorative film.

The decorative image overlay 20 may utilize latex saturated printing media, particularly for use in direct bonding of the decorative image overlay 20 without the use of self adhesive PVC film. Use of latex saturated printing media provides structural and permanent lamination to ceramic tile, glass, aluminum, composite board, vinyl composite tile, high pressure laminate floors and concrete. Images are printed to the latex saturated media using latex ink jet printing technology through ambient air cure systems or ultra violet (UV) curing processes. Bonding to the substrate-base coat layer relies on surface preparation using a blend of denatured alcohol and DMEA to provide an amine functional surface preparation.

An aqueous polyacrylate dispersion containing organic solvent cross-linked with water dispersible aliphatic polyisocyanate hardener may be used as an adhesive to bond the latex saturated media. The latex saturated media is top coated and monolithically sealed with a polyester-based, hydroxyl-functional, aliphatic, water-borne polyurethane dispersion that is cross linked and chemically cured with diisopropylcarbodiimide and or ethylene imine based tri-functional polyaziridine. These unique formulations of aqueous polyacrylate dispersions containing organic solvent and hydroxyl-functional, aliphatic, water-borne polyurethane dispersion provide interior, exterior installations and vertical or horizontal applications with superior results and long term durability.

Alternative embodiments of the functionally bonded system 10 may use other decorative image overlay material 20 such as various fabrics that can be used to print decorative media, such as highly detailed, photo quality digital images thereupon. The fabrics can be woven, non-woven, and consist of mixed blends of one or more fabric types. Preferably, the fabric used to create the decorative media should be capable of providing a strong chemical bonding as the fabric becomes part of the monolithic overlay, embedding in subsequently laid and previously fixed layers. Such fabric types include, but are not limited to, 1) plant textiles such as acetate, bark, bamboo, coir (coconut fiber), cotton, flax, grass, hemp, jute, kapok, model, nettle, paper, pina (pineapple paper), ramale, rayon, rush sisal, straw; 2) mineral textiles such as asbestos, basalt fiber, glass fiber, metal foil, metal wire; 3) synthetic textiles such as acrylic fiber, ingeo, lurex, lycra, nylon fiber, polyester fiber, olefin fiber, spandex, tactel; or 4) mixed fibers such as polyester/rayon.

The decorative image overlay material 20 is bonded to the base coat 18 through a decorative overlay material adhesive layer 22. The decorative image overlay material adhesive layer 22 is preferably formed of a resin, extremely hard, aliphatic, polyester-based, aqueous polyurethane dispersion with exceptional chemical and early water-resistance properties. As an illustrative example, the decorative image overlay material adhesive layer 22 is Hauthane HD-2117 (Hauthway Corporation, Lynn, Mass.). The decorative overlay material adhesive layer 22 further contains a cross-linker so that the decorative overlay material adhesive resin contains functional groups that provide for a molecular bonding. For example, the decorative overlay material adhesive layer 22 is cross-linked with a propylene imine tri-functional polyaziridine. The propylene imine tri-functional polyaziridine, such as Polyfunctional Aziridine PZ-28 (trimethylopropane tris(2-methyl-1-aziridine propionate, is compatible with aqueous coatings and adhesives to promote robustness in both physical and chemical properties. The aziridine end groups can react with active hydrogen found on carboxyl groups of acrylic emulsions or polyurethane dispersions to provide robust chemical cross-linking.

The decorative image overlay material adhesive layer 22 may further be diluted by adding distilled water in the range of 0.5% to 99%, and preferably approximately 10% distilled water to enhance the flow out. Bonding of the decorative image overlay 20 to the substrate-base coat layer through the decorative image overlay material adhesive layer 22 allows the layers to form a new “single” layer consisting of the several components, i.e. substrate, base coat, decorative image overlay image adhesive, and image overlay, chemically bonded as a single layer which cannot be separated without destroying the entire unit.

A top coat layer 24 is applied to the decorative overlay material 20 and acts as a protective sealant. The top coat layer 24 can be a polyurethane dispersion, such as aliphatic polyurethane, a cyclic aliphatic polyamide, a polyaspartic, a polycarbonate, poly ester, or fluoropolymers. An illustrative example of the top coat layer 24 may include a two part water-based, very low VOC polyurethane mat, satin or gloss finish. The top coat layer 24 may also include a cross-linker, such as, but not limited to, a hydrophilic aliphatic polyisocyanate based on hexamethylene diisocyanate (HDI), such as Bayhydur XP 2655. Alternatively, the top coat layer 24 may include generally high VOC solvents, such as, but not limited to, high VOC based alkyd enamel, high VOC based acrylic enamel, high VOC based acrylic lacquer, high VOC based polyurethane, and high VOC based methylates. Alternatively, the top coat 24 may include low or no VOC compounds such as water borne acrylics, water borne polyurethanes, water borne epoxies, two component water borne acrylics, or two component water borne polyurethanes. Additionally, 100% solid coatings, such as 100% solids epoxies, 100% solids polyaspartics or 100% solids UV curable polyurethanes may be utilized to form the top coat 24. Whatever components are used to make the top coat layer 24, the mixture may be diluted by the addition of water at 0.5%-99%, preferably by adding approximately 10%-60%, and most preferable approximately 50% distilled water, to enhance the flow out. A mid coat 25 may be applied prior to the addition of the top coat 24. Depending on the need or finish, the top coat layer can be applied in multiple layers.

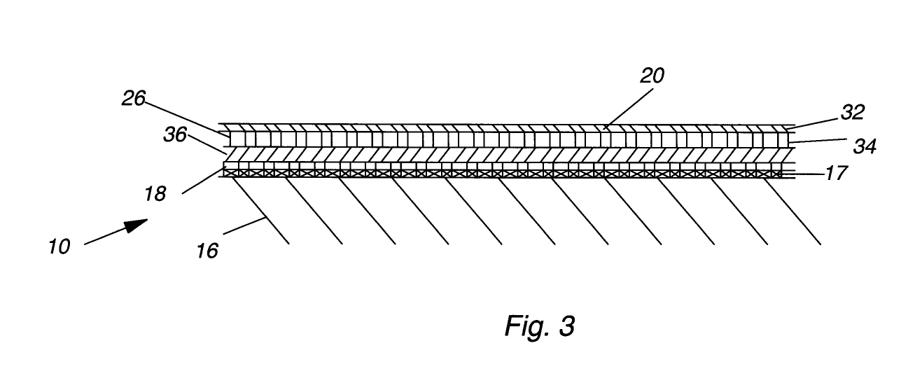

Referring to FIG. 3, an alternative embodiment of the present invention is illustrated. In this embodiment, the functionally bonded system 10 comprises the substrate 16 and the base coat 18. Depending on the substrate 16, in addition to the base coat described previously, the base coat 18 may be a two part mixture comprising 100% solids polyamine mixed with Portland cement or calcium carbonate filler. This base coat 18 embodiment may be used for substrates with rough surfaces, such as concrete or tile wherein grout lines are desired to be filled in to provide smooth surfaces. The mixture provides a self leveling compound that readily fills rough or grooved surfaces to a smooth surface. For substrate surfaces such as wood, laminate, engineered wood, VCT, porcelain, and ceramic, tile, stone and marble, the base coat 18 may be either a polyamide polymer base coating or an acrylic/urethane/polycarbonate/polyester coating catalyzed by a water dispersible aliphatic polyisocyanate hardener.

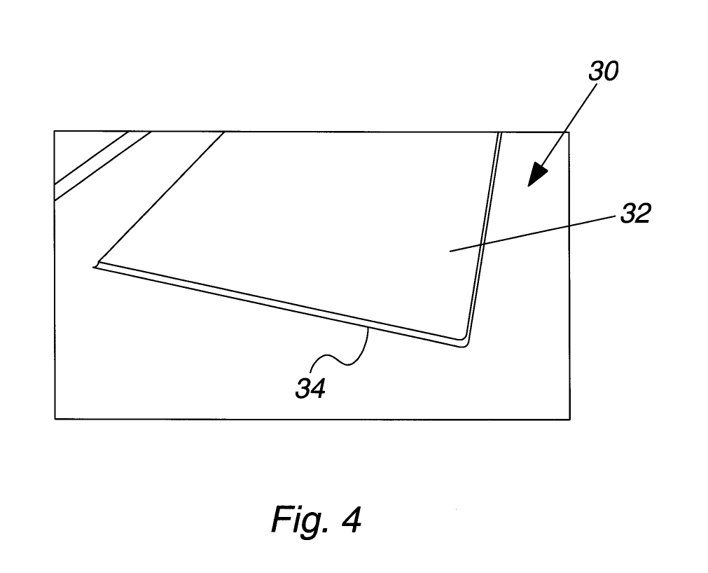

Bonded to the base coat 18 is a structure support member 26. The structure support member 26 may made of any material, such as concrete blocks, resins, glass, or wood. In an illustrative embodiment, the structure support member 26 is comprised of a phenolic material, such as a phenolic resin laminate (mixture of chemical compounds, aldehyde and phenol) to make up a phenolic structure support member 30, see FIGS. 3 and 4, having a first surface 32 and a second surface 34. Several characteristics of the phenolic structure support member 30 make it a useful material in the present invention. Use of the phenolic material as part of the functionally bonded system 10 may impart superior hardness and dimensional stability as compared to other synthetics. Additionally, the phenolic resin laminate may provide moisture resistance, corrosion resistance, fire resistance, impact resistance and provide long term prevention of surface wear and tear.

The phenolic structure support member 30 may be any thickness, supplied as individual components or as part of a sheet. Preferably, the phenolic structure support member 30 is a sheet of 1 mm thickness, cut to a preferred size or shape. In applications where a small groove is desired, such as in simulating hardwood flooring, hard wood mixed with inlaid stone, or a special desired pattern, the phenolic structure support member 30 is advantageous as it can be cut on a splitter, providing beveling on the edges. According to one embodiment of the present invention, a sheet of approximately 1 mm thick phenolic structure support member 30 has substantially the same outer dimensions as the stone, ceramic, tile surfaces, or the shape of hardwood boards or unique pattern designs. The phenolic structure support member 30 should also be designed to have a thickness to resist impact or static weight damage from such sources as furniture legs.

The second surface 34 is bonded to the base coat 18 through use of an adhesive material 36, such as double sided acrylic film adhesive. A removable protective paper may be added to the double sided acrylic film adhesive 36 to protect the adhesive, thereby preventing inadvertent sticking or damage to the adhesive side. The first surface 32 is bonded to the decorative overlay material 20. The decorative overlay material 20 may be decorative PVC film or other material described herein and provides for a decorative design in stone, marble, granite, wood, metal, logos, or the like. If a PVC film material is used, it is sized and shaped to have adequate strength to bear the coefficient stress of the phenolic structure support member and be able to be deformed elastically under the dynamic loading from the surface.

The present invention is further understood by a description of an illustrative method of forming and/or installing the functionally bonded system 10. The formation and/or installation procedure generally provides for a preparation stage in which the surfaces are prepared for bonding, one or more layers are secured to adjacent layers whereby individual components form a single unit, thereby forming a monolithically finished overlay with desired decorative features. The unique formation and/or installation procedure allows the functionally bonded system 10 to be laid onto a floor foundation or an existing floor (whether a traditional or a raised one) to produce a desired decorative floor covering such as marble, granite, stone, wood or exotic metals.

The functionally bonded system 10 is held firmly in place by the makeup of the coatings, whether the base coating, printed media adhesive coating, or top coating and/or the reaction of the underlying base coat make up and functional bonding chemistry. Whether using the phenolic support structure or not, the functionally bonded system 10 provides a system with minimal thickness and provides a decorative overlay that is not heavy, thereby minimizing any impairment of the integrity of the floor foundation or old floor underneath resulting from the weight of the system. Moreover, the present invention describes a unique overlay that provides a decorative floor having a desirable appearance that is durable, can be used in indoor and outdoor environments, and is environmentally friendly, both in the type of chemicals used to create the system, as well as by providing a system that replicates the look of natural resources, thereby minimizing the requirement of using, as well as removing, valuable natural resources from the environment.

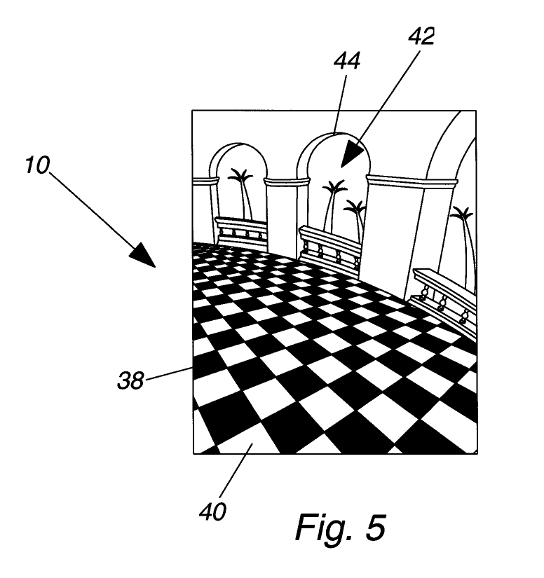

FIGS. 5-8 illustrate several examples of the finished functionally bonded system. Referring specifically to FIG. 5, the functionally bonded system 10 is shown in a residential setting. The functionally bonded system 10 contains a checkered pattern with alternating black squares 38 and white squares 40. The functionally bonded system 10 is installed in a room that is exposed to the outdoor environment 42 through open archway 44.

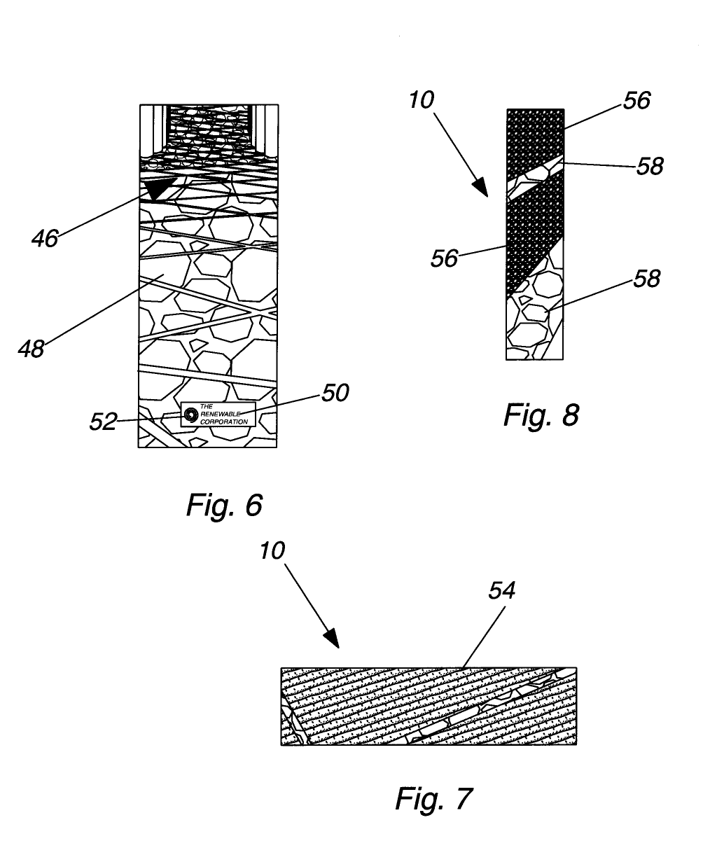

FIG. 6 illustrates the functionally bonded system 10 shown installed in the lobby 46 of a commercial building. The functionally bonded system 10 is shown having a decorative image replicating a marble floor 48. The decorative overlay 10 may also include design features, i.e. decorative or informative images, such as a corporate name 50 and a corporate logo 52, imprinted therein. FIGS. 7 and 8 show the functionally bonded system 10 with alternative images imprinted therein. FIG. 7 shows the functionally bonded system 10 with an image of a hardwood floor 54. FIG. 8 illustrates the functionally bonded system 10 with images of alternating sections of light colored granite tiles 56 and dark colored granite tiles 58.

The functionally bonded system 10 and method of forming and/or installing the system to a substrate advantageously alleviates tile laying operations and shortens the overall installation time required since, unlike conventional floor covering techniques, no adhesive or cement-based materials are necessary to bed the functionally bonded system 10 in place. In addition, no preliminary removing, shattering, demolition, or removal of millwork such as base moldings or trim or dislodging work is involved in laying them onto an existing floor. Thus, the procedure for forming and/or installing the functionally bonded system 10 according to the present invention is much easier than current flooring techniques and does not require special skills. Accordingly, installation of the functionally bonded system 10 can be carried out by unskilled personnel, thereby reducing the overall costs.

Example Method of forming and/or installing a monolithic, decorative and functional floor surface overlay:

The first step in the procedure provides a cleaning and activation step. To an existing substrate, whether it is an existing flooring system, i.e. tile or wood, or to a raw concrete surface, a cleaning/preparing substance is applied. In an illustrative example, functional bonding treatment solution described previously is used either independently or in combination with the base coat 18. Used independently or as applied to the base coat, the DMEA is diluted to provide enhanced flow and cleaning capability. The DMEA is preferably diluted to form a solution of 10% by volume denatured alcohol and 90% by volume DMEA. However, any other alcohol can be diluted with DMEA in ranges from between 1% and 99%. The DMEA is applied to the floor by spray, wipe or rolling and is applied in an area small enough to allow that area to be wiped of grime loosened by the applied mixture cloth. Should the alcohol or alcohol/glycol dry or evaporate from the DMEA, application may be difficult as the cloth used to apply the mixture will adhere to the surface being cleaned as a result of active amines on the surface. In installation over raw concrete, the DMEA/alcohol mixture may further be diluted with an appropriate amount of a polyisocyanate, such as hydrophilic-aliphatic polyisocyanate. The substrate-base unit that is formed uses activated functional chemical bonds to form a monolithic unit, instead of traditional mechanical bonding.

When the functional bonding treatment solution is applied separately from the base coat 18, the base coat 18 is applied to the substrate 16 using any application technique known to one of skill in the art, including rolling or spraying. The base coat 18 is usually tinted to allow the color to show through the printed cloth to enhance the definition and color.

Once the base coat 18 has been applied and bonds to the substrate 16 to form a substrate-base layer, the decorative overlay material 20 is bonded to the substrate-base coat layer using the decorative overlay material adhesive 22. Prior to bonding, the decorative overlay material layer 20, described herein as the printed fabric, is dry fit on the floor and trimmed to fit the room/flooring dimensions. The printed fabric can be encapsulated and bonded to the substrate-base coat layer using several techniques. One technique utilizes the decorative overlay material adhesive 22. Using this technique, the installer places the printed fabric 20 over the base coat 18. The installer then applies, i.e. pours, the decorative overlay material adhesive 22 over the printed fabric 20 resting on top of the dried substrate-base coat layer. The adhesive is spread evenly over the fabric using, for example a squeegee. The squeegee also drives the decorative overlay material adhesive 22 through the fabric 20, thereby wetting and bonding it to the base coat 18. To remove any wrinkles, creases, or bubbles and to insure the coating is integrally wet into the substrate-base coat layer, the cloth may be used to wipe the surface using a wiping pattern. The wiping pattern also serves to tighten the weave to eliminate any stretching that has occurred in the preceding steps.

To the chemically encapsulated printed material, one or more top coat 24 applications can be applied to achieve a desired smoothness, depth and gloss level. The top coat 24 can be one of several water based or solvent based coats disclosed or can be a UV cured top coat which allows immediate return to use of the surface.

If the support structure member 26 is used in the process, it is chemically bonded to the base coat 18 along surface 34 and to the printed material 20 along surface 32. If thresholds are present between existing tile and former carpeted areas, underlayment board can be use to gain near evenness across the desired installation area, and then the self leveling version of the base coat 18 can be used to gain an effectively leveled and flat surface for installation.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A decorative, monolithic, functionally bonded system comprising:
a functional bonding solution adapted for creating a bond to between a base layer and a substrate;
a base layer composition, said base layer composition having one or more components that forms a permanent bond with a substrate to form a base layer-substrate composition,
a substrate; and
a decorative image overlay having at least one form of printed indicia printed thereto, said decorative image overlay bonded with said base layer-substrate composition to form a decorative, monolithic, functionally bonded system.

2. The decorative, monolithic, functionally bonded system according to claim 1 further including a protective layer composition, said protective layer bonded to said monolithic, decorative and functional surface overlay.

3. The decorative, monolithic, functionally bonded system according to claim 1 wherein said base layer includes at least one organic compound having a functional group adapted to bind to said substrate through a chemical bond.

4. The decorative, monolithic, functionally bonded system according to claim 3 wherein said functional group is an amine group.

5. The decorative, monolithic, functionally bonded system according to claim 3 wherein said base layer includes an aqueous hydroxyfunctional polyacrylic dispersion, a polyester, a polyurethane, a polycarbonate, a polyaspartic, or combiantions thereof.

6. The decorative, monolithic, functionally bonded system according to claim 3 wherein said base layer includes a polyisocyanate.

7. The decorative, monolithic, functionally bonded system according to claim 6 wherein said polyisocyanate is a hydrophilic aliphatic polyisocyanate.

8. The decorative, monolithic, functionally bonded system according to claim 1 wherein said base layer further includes a functional bonding solution.

9. The decorative, monolithic, functionally bonded system according to claim 8 wherein said functional bonding solution is a solvent having N—N-dimethylethanolamine.

10. The decorative, monolithic, functionally bonded system according to claim 1 wherein said base layer includes ultra violet radiation curable materials.

11. The decorative, monolithic, functionally bonded system according to claim 1 wherein said base layer includes colored compounds or pigments for providing tinting.

12. The decorative, monolithic, functionally bonded system according to claim 1 wherein said substrate is a preexisting surface.

13. The decorative, monolithic, functionally bonded system according to claim 12 wherein said preexisting surface is concrete, tile, a natural hardwood, a synthetic wood material, stone, marble, underlayment, glass, synthetic boards, glass top, architectural glass, or combinations thereof.

14. The decorative, monolithic, functionally bonded system according to claim 1 wherein said decorative image overlay is a latex saturated printing media.

15. The decorative, monolithic, functionally bonded system according to claim 1 wherein said decorative image overly is a woven fabric, a non-woven fabric, or combinations thereof.

16. The decorative, monolithic, functionally bonded system according to claim 1 wherein said printed indicia of said decorative image overlay replicates a natural material.

17. The decorative, monolithic, functionally bonded system according to claim 1 wherein said printed indicia includes words, design features, or combinations thereof.

18. A method of forming a decorative, monolithic, functionally bonded system comprising the steps of:
identifying a substrate to be covered with a monolithic, decorative and functional surface overlay system;
applying a base layer to said substrate;
forming a first portion of a multi-component forming a decorative, monolithic, functionally bonded system, said first portion formed by a bond between said base layer and said substrate thereby forming a base layer-substrate unit;
applying a decorative layer having at least one form of printed indicia thereto, said second layer adapted to form a chemical bond with said base layer-substrate composition; and
bonding said decorative layer to said base layer-substrate unit to form a second portion of said multi-component forming a decorative, monolithic, functionally bonded system.

19. The method of forming a decorative, monolithic, functionally bonded system according to claim 18 further including the step of applying a functional adhesive coating to said bonded decorative layer.

20. The method of forming a decorative, monolithic, functionally bonded system according to claim 19 wherein said functional adhesive coating is a polyurethane dispersion, polycarbonate, polyester, or a polyaspartic.

21. The method of forming a decorative, monolithic, functionally bonded system according to claim 18 further including the step of preparing said surface for bonding with said base layer.

22. The method of forming a decorative, monolithic, functionally bonded system according to claim 18 wherein at least one component of said monolithic, decorative and functional surface overlay contains a UV curable material.

23. The method of forming a decorative, monolithic, functionally bonded system according to claim 22 further including the step of applying a UV curing source to one or more components of said system.

24. The method of forming a decorative, monolithic, functionally bonded system according to claim 18 wherein said decorative image is a latex saturated printing media.

25. The method of forming a decorative, monolithic, functionally bonded system according to claim 18 wherein said decorative image is made from a woven fabric, a non-woven fabric, or combinations thereof.
